(19) United States
(12) Patent Application Publication
(10) Pub. No.: US 2013/0307799 A1
(43) Pub. Date: Nov. 21, 2013

(54) TOUCHSCREEN WITH ANALOG PRESSURE DETECTION AS USER INTERFACE FOR INDUSTRIAL TECHNICAL DEVICE

(71) Applicant: Siemens Aktiengesellschaft, Munchen (DE)

(72) Inventor: Ronald Hauf, Mohrendorf (DE)

(73) Assignee: Siemens Aktiengesellschaft, Munchen (DE)

(21) Appl. No.: 13/894,951

(22) Filed: May 15, 2013

(30) Foreign Application Priority Data
May 16, 2012 (EP) 12168253

(51) Int. Cl. G06F 3/041

(52) U.S. Cl. CPC G06F 3/0414
USPC 345/173

(57) ABSTRACT

Pressure is applied to an area of a touchscreen by an operator of an industrial technical device. A value dependent on the applied pressure is generated by a sensor device associated with the area and supplied to an evaluation device. In a normal operating mode, a variable dependent on the applied pressure is transmitted by the evaluation device to a control device. The control device activates an element of the industrial technical device and outputs to the element a setpoint value dependent on the applied pressure, when the pressure defined by the transmitted variable exceeds a first threshold value. The setpoint value is a monotonously increasing function of the pressure and has the value zero until the pressure exceeds a second threshold value greater than the first threshold value.

### CROSS-REFERENCES TO RELATED APPLICATIONS

This application claims the priority of European Patent Application, EP 12 168 253, filed May 16, 2012, pursuant to 35 U.S.C. 119(a)(d), the content of which is incorporated herein by reference in its entirety as if fully set forth herein.

### BACKGROUND OF THE INVENTION

The present invention relates to a method for operating an industrial technical device and to an industrial technical device.

The following discussion of related art is provided to assist the reader in understanding the advantages of the invention, and is not to be construed as an admission that this related art is prior art to this invention.

Conventional hard-keys and soft-keys are generally used on operating panels, mobile operating panels and machine control panels for operation of machines. Only one function is ever assigned to such keys, which is activated by pressing the corresponding key and deactivated by releasing the corresponding key. With hard-keys the function is always the same. With soft-keys the keys are allocated a respective function depending on the overall state of the industrial technical device.

The use of a touchscreen as an operator interface is also known in the prior art. With touchscreens, touching the touchscreen can be detected and reacted to accordingly. Individual areas of the touchscreen in a similar way to soft-keys can be assigned a variable function.

Because of the situation that hard keys and soft-keys are essentially assigned binary functions, in the prior art, during the movement of axes or spindles on machines, as a rule the axis to be moved in each case will be activated by actuating one key. The associated speed of movement or rotational speed is set via a separate electromechanical rotary switch (override). In the prior art two actions are thus generally required which, especially during operation with a mobile panel, does not allow an ergonomically sensible operating sequence. As an alternative the operator actions can be carried out sequentially. This method of operation too is not ergonomically viable. Operator interfaces, in which both the choice of axis to be moved and/or the drive to be activated and also a setpoint value can be predefined by means of a single key, are not known in the prior art.

Recently, analog-resistive sensors have become known which are suitable for touchscreens and which can detect pressure applied to them in an analog or quasi-analog manner. Purely by way of example the reader is referred to corresponding products made by Peratech, England, especially the product “QTC Clear” and to so-called piezoelectric functional polymers. Both systems enable analog and high-resolution detection of the pressure on the touchscreen.

It would therefore be desirable and advantageous to obviate prior art shortcomings and to enable improved one-handed operation of an industrial technical device in a simple and reliable manner.

### SUMMARY OF THE INVENTION

According to one aspect of the present invention, a method for operating an industrial technical device includes applying a pressure on an area of a touchscreen by an operator of the industrial technical device, generating a value dependent on the applied pressure by a sensor device associated with the area, supplying the generated value to an evaluation device, in a normal operating mode, transferring a variable that depends on the applied pressure from the evaluation device to a control device of the industrial technical device, and activating with the control device an element of the industrial technical device and outputting a setpoint value when the pressure defined by the transferred variable exceeds a first threshold value, wherein the setpoint value depends on the applied pressure to the element and is a monotonously increasing function of the pressure, and wherein the setpoint value has a value of zero until the applied pressure increases beyond a second threshold value greater than the first threshold value.

The setpoint value thus does not already assume a value not equal to 0 if the corresponding area of the touchscreen is touched, but only when an appreciable pressure is actually applied to the corresponding area. Advantageously, the first threshold value is thus located above the minimally detectable pressure. Furthermore, an additional different pressure level is preferably located between the first and the second threshold value. The setpoint value may for example, be a force, a rotational speed or a velocity setpoint value.

According to an advantageous feature of the present invention, the derivative of the setpoint value with respect to pressure may also be a monotonously increasing function. With this embodiment, a delicate application of the activation of the drive can be undertaken with relatively small pressures, while a high setpoint value can be achieved quickly through heavy pressure.

Advantageously, the setpoint value may be independent of the state of the industrial technical device. However, the setpoint value may also be a function of a state of the industrial technical device at the time of activation of the element.

According to another advantageous feature of the present invention, tactile detectable feedback specific to the setpoint value may be outputted to the operator by an actuator. This also enables the operator to receive feedback about the reaction that he has caused when he has neither the industrial technical device nor the operator interface in his field of view.

According to another advantageous feature of the present invention, the reaction to the applied pressure may include activation of a commensurate number of elements of the industrial technical device and the number of activated elements may be a monotonously increasing function of the applied pressure.

According to another advantageous feature of the present invention, the value dependent on the applied pressure may be generated by the sensor device in a fault-tolerant manner, and/or the value dependent on the applied pressure may be supplied to the evaluation device in a fault-tolerant manner, and/or the variable dependent on the applied pressure may be determined by the evaluation device in a fault-tolerant manner and transferred to the control device, and/or the reaction dependent on the applied pressure may be determined and executed by the control device in a fault-tolerant manner.

With this method of operation, the industrial technical device can be operated in a fault-tolerant manner. To guarantee fault-tolerant operation, there must also be detection in a fault-tolerant manner of whether pressure is being applied to the corresponding area of the touchscreen. Optimally, the applied pressure may also to be detected by the sensor device in a fault-tolerant manner. Alternatively, however, it is sufficient for the applied pressure, i.e. the analog value not to be detected in a fault-tolerant manner and additionally the (binary) pressure on the corresponding area to be detected via a further channel.

Furthermore,
a timer having a predefined end time may be started when pressure is no longer applied,
the timer may be reset when the operator starts again to apply pressure on the area of the touchscreen or on another area of the touchscreen before the predefined end time is reached,
the process may transition to a special operating mode special operating mode when the operator fails to apply pressure on the area of the touchscreen or on another area of the touchscreen before the predefined end time is reached, and
the reaction of normal operating mode is not determined and executed by the control device when the operator, in the special operating mode, either applies pressure on the area of the touchscreen or applies renewed pressure on another area of the touchscreen.

This approach can prevent, on one hand, an operating action from being initiated by an accidental first touch and, on the other hand, an operating action from being initiated when, for example, a foreign body comes into contact with the touchscreen or the operator interface (in the case of a mobile operator interface) falls onto the floor or the like.

Of course, it must be possible to leave the special operating mode again. A check is thus made when in the special operating mode as to whether the operator predefines a switchover command. When the switchover command is predefined, a switchover occurs from special operating mode into normal operating mode. In accordance with the invention, however, the switchover command is an operating action which differs from the action of a single exertion of pressure on an individual area of the touchscreen. For example, the switchover command may be a longer actuation of a separate key or of a number of separate keys or the simultaneous actuation of, on one hand, one key and, on the other hand, pressing of a specific area of the touchscreen. It is also possible for the switchover command to be defined by a predefined input sequence.

According to another aspect of the invention, an industrial technical device includes an operator interface having a touchscreen with at least one area to which a pressure is applied by an operator of the industrial technical device, a sensor device associated with the at least one area, the sensor device being configured to generate a sensor value dependent on the applied pressure, a control device having a first interface, and an evaluation device connected to the sensor device for receiving the sensor value and generating an evaluated variable. The evaluation device includes a second interface to the control device configured to transfer the evaluated variable to the first interface of the control device. The control device is also configured to activate an element of the industrial technical device and to output to the element a setpoint value dependent on the applied pressure when the applied pressure defined by the evaluated variable exceeds a first threshold value, wherein the setpoint value is a monotonously increasing function of the applied pressure, and has a value of zero until the applied pressure becomes greater than a second threshold value greater than the first threshold value.

According to another advantageous feature of the present invention, the operator interface may be embodied as a mobile operator interface. With a mobile operator interface, the operator must sometimes hold the operator interface with one hand, so that from the outset only single-handed operation is possible.

Advantageously, the touchscreen may be disposed on an upper side of the operator interface. The operator interface may advantageously have a handle disposed, for example, on the underside. The operator can then hold the operator interface in a comfortable and simple manner.

According to another advantageous feature of the present invention, the handle of the operator interface may have at least one actuation element, wherein the actuation element may be connected for signaling to the evaluation device and actuation of the actuation element may be evaluated by the evaluation device in addition to the application of pressure on the area of the touchscreen. With this embodiment even greater operational safety can be attained. For example, drives may only be activated when the actuation element is additionally actuated. In addition, the actuation element may be operated like the dead man's handle known in railroad technology, i.e. that it must be actuated regularly. Other uses are also possible, for example a combination of functions or a functional self-latching.

The interface from the evaluation device to the control device of the industrial technical device is preferably embodied as a wireless interface. For example the interface can be embodied as a radio link.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a block diagram of an industrial technical device according to the present invention,

FIG. 2 shows an operator interface,

FIG. 3 shows a functional representation of the operator interface and a control device,

FIG. 4 shows a pressure diagram,

FIGS. 5 to 7 show flow diagrams,

FIGS. 8 and 9 show pressure diagrams,

FIG. 10 shows a flow diagram,

FIG. 11 shows a step in a flow diagram,

FIG. 12 shows a flow diagram,

FIG. 13 shows a possible embodiment of an operator interface,

FIG. 14 shows the underside of the operator interface from FIG. 13, and

FIG. 15 shows a timing diagram.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

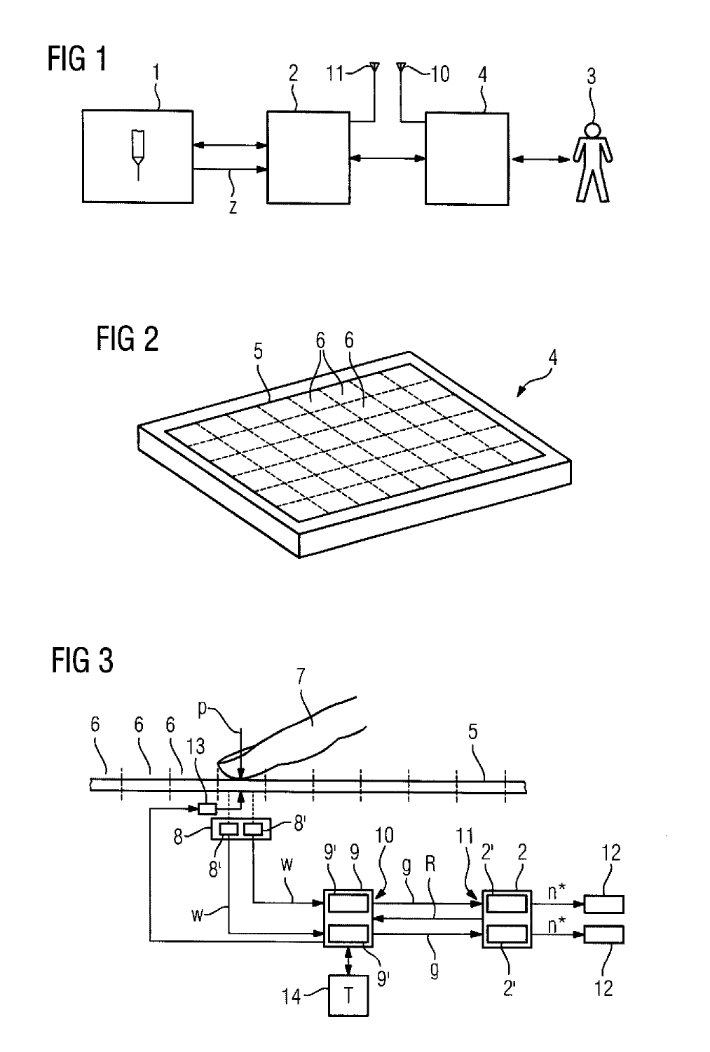

Turning now to the drawing, and in particular to FIG. 1, there is shown an industrial technical device 1—in the illustrated embodiment a drilling machine—which is controlled by a control device 2. The control device 2 accepts inputs from an operator 3 of the industrial technical device 1 via an operator interface 4, which he intends to enter as part of the control of the industrial technical device. Furthermore the control device 2 issues outputs and information to the operator 3 via the operator interface 4.

In accordance with FIGS. 2 and 3 the operator interface 4 has a touchscreen 5. The touchscreen 5 in accordance with FIG. 2 has at least one area 6 on which a pressure p can be applied by the operator 3. As a rule many such areas 6 are present, wherein the areas 6 are arranged in a two-dimensional matrix. For example 100×100 areas 6 or even more can be present. The areas 6 are assembled into groups, with each group corresponding to a touchkey element.

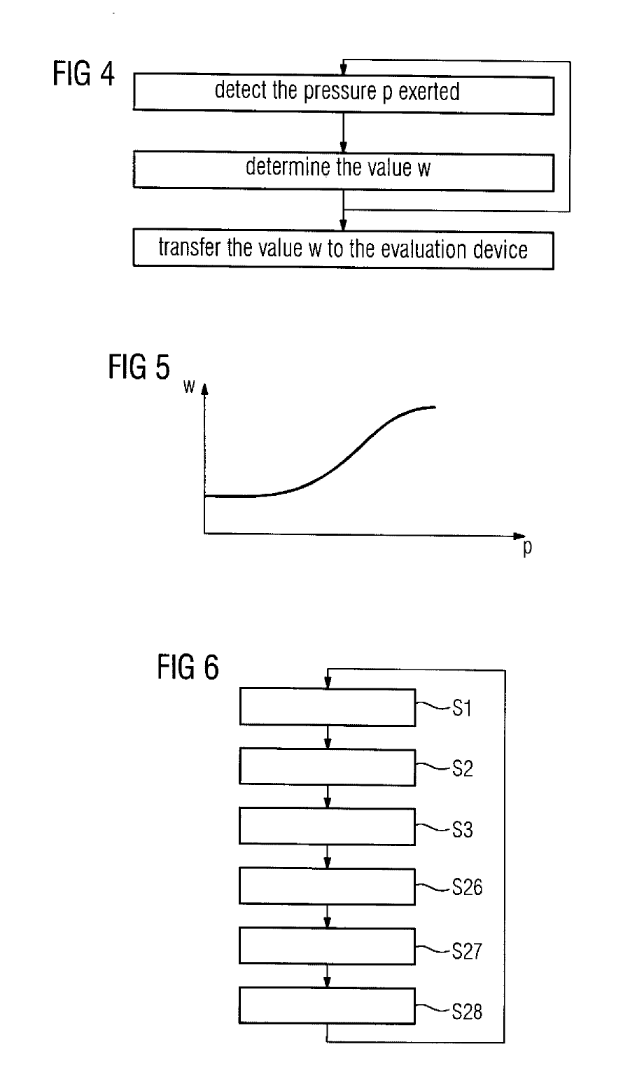

When the corresponding pressure p is applied by the operator 3—with one of his fingers 7 for example—in accordance with FIGS. 3 and 4 this is detected by a sensor device 8 assigned to a corresponding area 6. In accordance with FIG. 4 the sensor device 8, as a result of the applied pressure p applied, generates a value w which is dependent on the pressure p, i.e. which is a measure of the level of applied pressure p. The value w can for example be an electrical voltage or an electrical current. The value w can, in accordance with FIG. 5, be a linear or non-linear function of the applied pressure p. The precision with which the pressure p is detected is of lesser importance. For example 5, 8, 10, 50, 100 different levels of pressure are able to be distinguished. The decisive factor is that not only is a distinction made between the states “pressed” and “not pressed”, but also information about the level of applied pressure p is available.

The sensor device 8 supplies the value w generated by it which depends on the applied pressure p, to an evaluation device 9. The evaluation device 9 is a component of the operator interface 4. The evaluation device 9 is connected to the sensor device 84 transfer of the corresponding value w from the sensor device 8 to the evaluation device 9. The evaluation device 9 accepts the value w generated by the sensor device 8 in accordance with FIGS. 3 and 6 in a step S1. It determines on the basis of the excepted value w in a step S2 a variable g dependent on the pressure p.

The type of variable g determined and its resolution can—similarly to the value w dependent on the applied pressure p—be as required. The decisive factor is that in accordance with the diagram shown in FIG. 5, on the basis of the determined variable g, not only the states “pressed” and “not pressed” can be distinguished, but—for example within the framework of an 8-bit resolution—also information about the level of applied pressure p is available. In the simplest case the variable g can be identical to the value w or can be a digitization of the—mostly analog—value w.

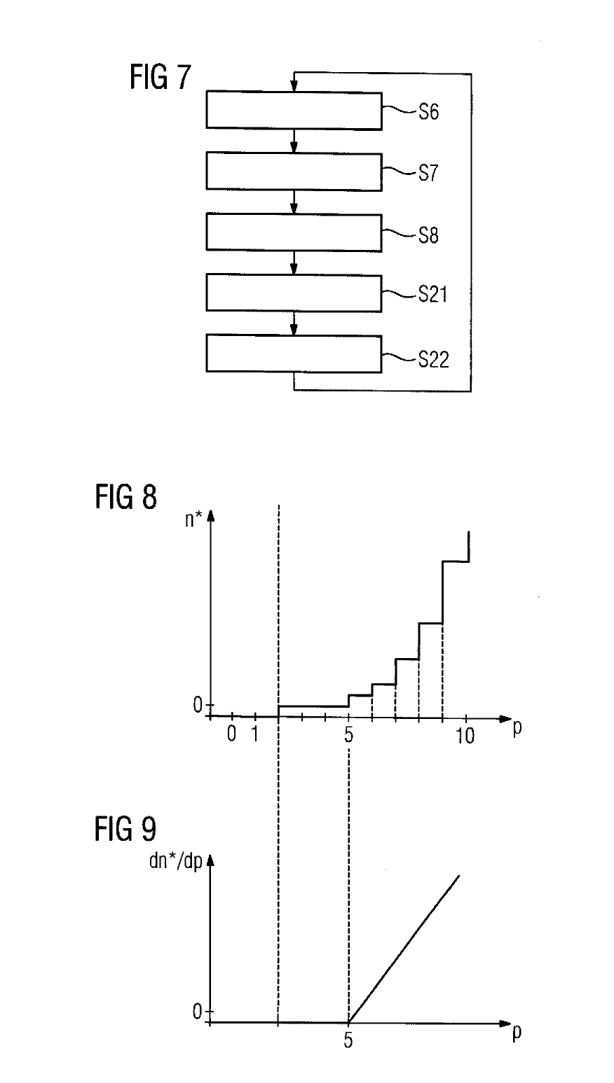

In accordance with FIG. 3 the evaluation device 9 has an interface 10 to the control device 2. Via the interface 10 the evaluation device 9 transfers the variable g dependent on the applied pressure p in step S3 to the control device 2. The control device 2 likewise has an interface 11, which has a data link to the interface 10 of the evaluation device 9. In accordance with FIGS. 3 and 7 the control device 2 accepts the variable g dependent on the applied pressure p outputted by the evaluation device 9 and via its interface 10 in a step S6. It determines a reaction on the basis of the variable g transferred to it in a step S7 and carries out the reaction in a step S8. Because of the fact that the transferred variable g depends on the applied pressure p, the reaction determined and carried out can also depend on the applied pressure p.

The reaction dependent on the applied pressure p can differ in its nature. FIG. 8 shows a possible reaction. In FIG. 8 it is assumed that the variable g dependent on the applied pressure p is transferred digitally, so that the pressure p is available as a quantized variable. The numbers 0, 1, 2, 3 plotted on the right in FIG. 8 designate the levels of pressure able to be distinguished. 0 corresponds to no pressure, 1 corresponds to the smallest detectable pressure differing from 0; the other values represent in a strictly monotonously increasing sequence further pressures able to be distinguished.

In accordance with FIG. 8 an element 12 of the industrial technical device 1 (see FIG. 3) at least temporarily assigned to the corresponding area 6 is activated by the control device 2 when a specific area 6 of the touchscreen 5 is pressed—i.e. on detection of a pressure p above a first threshold value. The first threshold value can be equal to the minimally detectable pressure (pressure level 1) or lie above said pressure, for example in accordance with the diagram shown in FIG. 8 for pressure level 2. Furthermore a corresponding setpoint value n* is output to the element 12. In accordance with FIG. 8 the setpoint value n* is a monotonously increasing function of the pressure p. The element 12 can for example be a drive or a press.

It is possible to set the setpoint value n* as soon as it is activated to a value greater than 0. Preferably the setpoint value n* has the value 0, until the applied pressure p exceeds a second threshold value. As a rule at least one further distinguishable pressure level lies between the first and the second threshold value.

The type of setpoint value n* can be selected as required. Often it involves a force, rotational speed or velocity setpoint value.

As can already been seen from FIG. 8, the setpoint value n* initially increases slowly, as the pressure p increases and then increases ever more quickly. Preferably in accordance with the diagram shown in FIG. 9 it is therefore not only the setpoint value n* itself, but also the derivation dn*/dp of the setpoint value n* according to the pressure p that is a monotonously increasing function of the pressure p. For reasons of simplifying the diagram, in FIG. 9 the quite fine quantization has not been shown.

It is possible for the curve of the setpoint value n* as a function of the pressure p to be independent of other variables. As an alternative such a dependency can exist. In particular the setpoint value n* can additionally be a function of a state Z of the industrial technical device 1 at the time of the activation of the element 12. This is explained in greater detail below in conjunction with FIG. 10.

In accordance with FIG. 10, in a step S11 the control device 2 accepts the variable g dependent on the applied pressure p. It checks in a step S12 whether the pressure p in accordance with the previously transferred variable g—i.e. not the pressure p in accordance with the variable g now currently being transmitted—is located below the first threshold value. If this is the case, the control device 2, in a step S13 determines the current state Z of the industrial technical device 1. On the basis of the detected state Z, it determines in a step S14 the functional curve of the setpoint value n* as a function of the pressure p. For example the control device 2 can scale the curve shown in FIG. 8 with a factor, with the factor depending on the detected state Z.

In a preferred embodiment of the present invention the control device 2 determines in accordance with FIG. 7 in a step S21 on the basis of the reaction determined and carried out by it, a response R are and transfers the response R in a step S22 to the evaluation device 9. The evaluation device 9 accepts the response R in accordance with FIG. 6 in a step S26. In a step S27 the evaluation device 9 determines on the basis of the response R activation for an actuator 13. The evaluation device 9 controls the actuator 13 in accordance with FIGS. 3 and 6 in a step S28 in accordance with the activation determined. The actuator 13 is a mechanical—preferably a micromechanical—actuator 13. The activation of the actuator 13 therefore generates a mechanical effect (response), which is able to be detected 3 as a tactile response by the operator 3.

It is possible for the actuator 13 to be assigned to the area 6 on which the operator 3 is exerting the pressure p. As an alternative an actuator 13 can be present in each case for a number of respective areas 6. As a further alternative the same actuator 13 can always be activated.

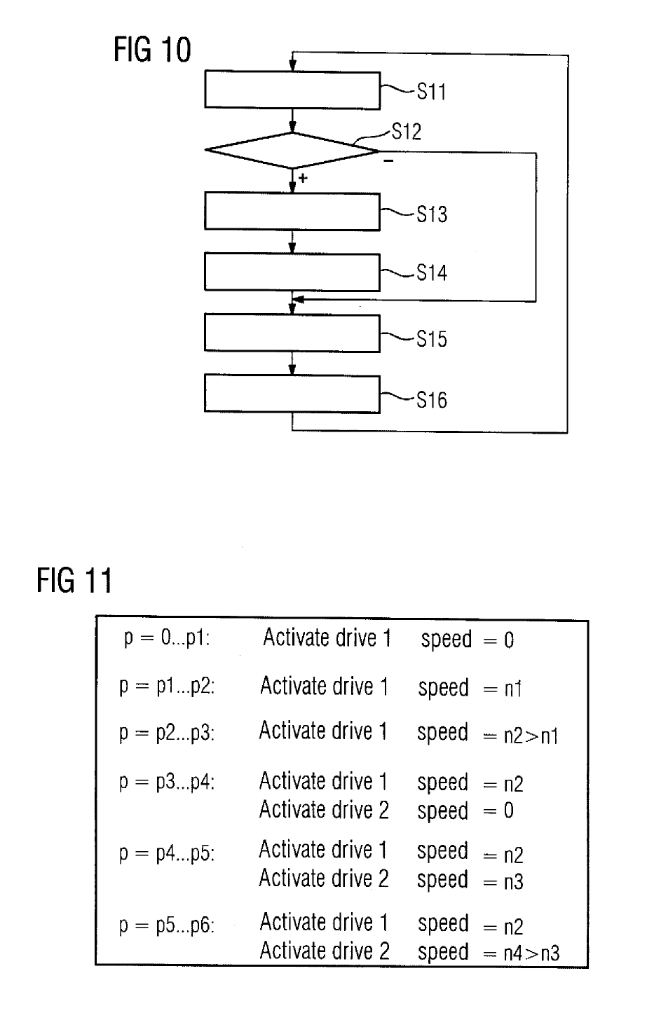

As an alternative or in addition to an activation of a (single) element 12 of the industrial technical device it is possible for the control device 2 to activate a number of elements 12 as a function of the applied pressure p. In this case the number of activated elements 12 is a monotonously increasing function of the applied pressure p. FIG. 11 shows—purely by way of example—an embodiment, in which by a pressure p increasing from p1 via p2, p3 etc. a first drive 12 and then a second drive 12 is activated, wherein consecutively increasing rotational speed setpoint values n1 to n4 are output to the drives 12—beginning with 0.

An example of a possible application with the activation of a number of drives 12 is for instance initially to activate a drill spindle, then to apply the drive spindle at a low rotational speed n1, then to apply the drive spindle at a high rotational speed n2 and only thereafter to lower the drive spindle slowly at first (n3) and more quickly later (n4) along its axis of rotation, so that a hole is drilled in a workpiece.

The activation of elements 12 is a safety-oriented action. Accidental incorrect triggering because of a malfunction of the sensor device 8, the evaluation device 9 etc. must therefore be avoided. The applied pressure p is therefore preferably detected by the sensor device 8 in a fail safe manner. For example the sensor device 8 in accordance with FIG. 3 can have two sensors 8′, which detects the pressure p independently of one another (then thus in a fail safe manner) and generate the corresponding value w and supply it to the evaluation device 9. As an alternative, by means of a further sensor device not shown, the pressing of the corresponding area 6 of the touchscreen 5 can be detected in a purely binary way.

The evaluation device 9 is likewise embodied in a fail safe manner. For example it can consist of two part devices 9′ operating independently of one another, to which the respective value w is supplied by a sensor 8′ in each case, which evaluates the value w supplied to them independently of one another and which monitor each other. The evaluation device 9 thus evaluates the value w transferred to it in a fail safe manner. Furthermore the variable g is also determined in a fail safe manner and transferred to the control device 2. For example—like the signal path from the sensor device 8 to the evaluation device 9—transmission can be duplicated.

The control device 2 is also embodied in a failsafe way. For example it can consist of two subunits 2′ operating independently of one another and monitoring one another. Fail-safe control devices are generally known in the prior art. The control device 2 thus determines in a fail-safe way the corresponding reaction depending on the applied pressure p and executes the same in a failsafe way.

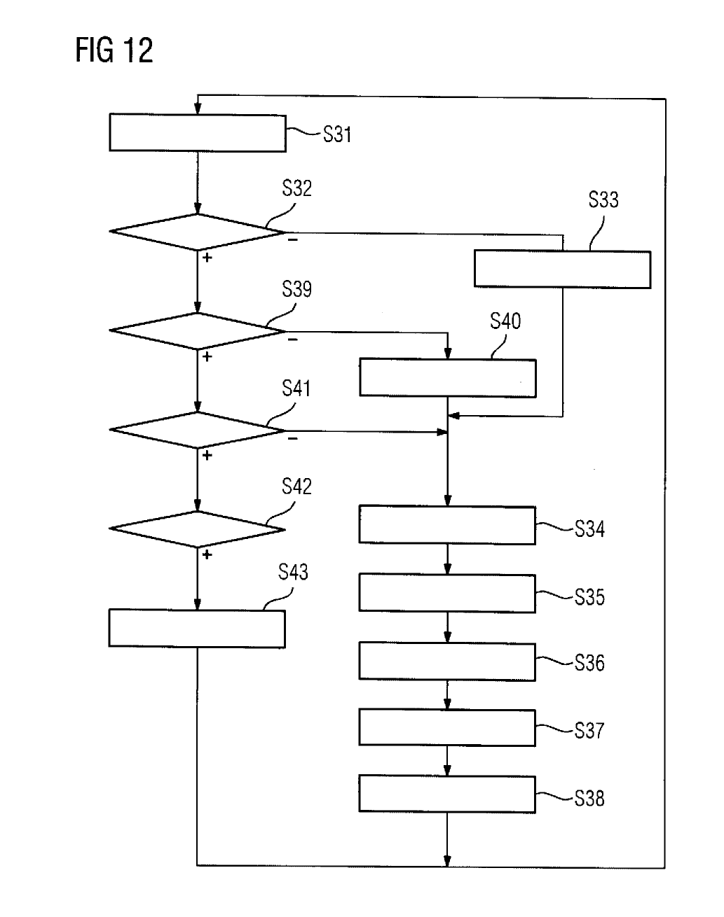

There can be further embodiments of the modes of operation explained above. For example it is possible to operate the evaluation device 9 in such a way as is explained in greater detail below in conjunction with FIG. 12.

In the case of the embodiment in accordance with FIG. 12 the evaluation device 9 is either operating in a normal operating mode or in a special operating mode. In normal operating mode the evaluation device 9, in a step S31 accepts the value w depending on the applied pressure p. In a step S32 it checks whether the applied pressure p differs from 0 i.e. whether any pressure p at all is being applied. If the pressure p differs from 0 the evaluation device 9 resets a timer 14 (see FIG. 3). The timer 14 is a component of the operator interface 4.

Furthermore the evaluation device 9 determines in a step S34 the variable g dependent on the applied pressure p. The evaluation device 9 outputs the variable g in a step S35 to the control device 2.

If the control device 2 generates the response R, the evaluation device 9 accepts the response R in a step S36. In a step S37 it determines in this case the associated activation of the actuator 13 and controls the actuator 13 in a step S38 in accordance with the activation determined.

If it was detected in step S32 that the pressure p is 0, the evaluation device 9 moves to a step S39. In step S39 the evaluation device 9 checks whether the timer 14 is already running. If this is not the case, the evaluation device 9 moves to a step S40 in which it starts the timer 14. Then it moves to step S34.

The timer 14 has a predefined time T. The time T can be defined as required. For example it can lie (somewhere) between 20 s and 5 min. If the timer 14 is already running, the evaluation device 9 checks in a step S41, whether the timer 14 has elapsed, i.e. has reached the time T. If this is not the case, the evaluation device 9 moves to step S34.

Provided this has been explained previously, the method of operation of FIG. 12 corresponds to the normal operating mode of the evaluation device 9 and as a result is therefore also of the industrial technical device 1. If however the outcome of the check in step S41 is positive, i.e. the timer 14 has expired, no pressure p has been applied to any area 6 of the touchscreen 5 before the expiry time T was reached. In this case the evaluation device 9 moves to a step S42. Step S42 corresponds to a special operating mode of the evaluation device 9 and thus as a result also of the industrial technical device 1.

In special operating mode the evaluation device 9 ignores whether pressure p has been applied to area 6 of the touchscreen 5. In this case the area 6 of the touchscreen 5 on which pressure p might be applied is irrelevant. The evaluation device 9 might thus possibly accept the pressure-dependent value w. However it does not transfer the corresponding variable g to the control device 2. The control device 2 therefore also does not determine the corresponding reaction which would have been determined in normal operating mode. Nor does the control device 2—naturally—carry out this reaction.

It must be possible to exit from special operating mode again. The evaluation device 9 therefore checks within the framework of step S42 whether a switchover command has been predefined to it by the operator 3. If it has been, the evaluation device 9, in a step S43 resets the timer 14 and then returns to step S31 and thus goes back into normal operating mode.

The switchover command is an action taken by the operator 3, which is an action by the operator 3 which differs from a single exertion of pressure on a single area 6 of the touchscreen 5. For example one of the following methods of operation is possible:
Reset from the control device 2.
Pressing a special reset button of the operator interface 4.
Switching the operator interface 4 off and switching it back on again.
Entry of a predetermined sequence of touches of predefined areas 6 of the touchscreen 5. For example it can be requested that first of all a first area 6 of the touchscreen 5 is touched twice, then a second area 6 of the touchscreen 5 is touched three times and finally a third area 6 of the touchscreen 5 is touched twice.

Other variants are also conceivable.

It is possible to vary the method of operation explained above in conjunction with FIG. 12. On the one hand it is possible to omit the steps S39 and S40 without replacing them. This is possible if the timer 14 is running permanently provided it does not reach the expiry time T. Furthermore it is possible, to transfer the method of operation explained in conjunction with FIG. 12 to the control device 2. In this case the step S31 from FIG. 12 must be replaced by step S6 from FIG. 7. Steps S34 to S38 must be replaced in this case by steps S7, S8 and if necessary S21 and S22 from FIG. 7.

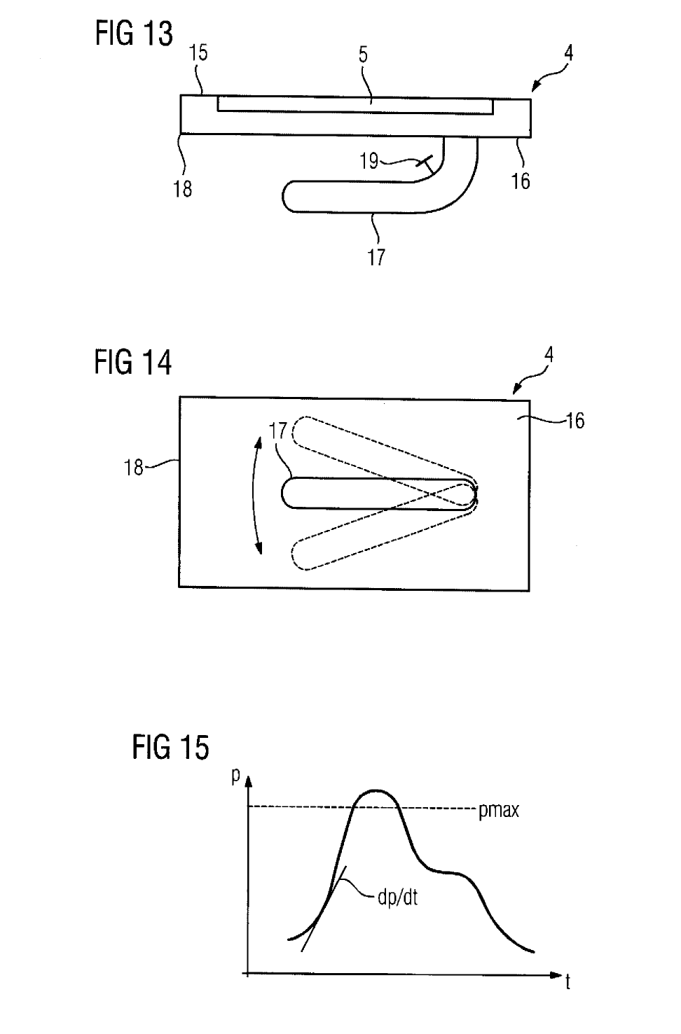

The operator interface 4 can be embodied as a permanently installed operator interface 4. Preferably the operator interface 4 is embodied however in accordance with the diagram shown in FIG. 13 as a mobile operator interface 4. In particular in this case the operator interface 4 can have a handle 17. The touchscreen 5 is disposed on an upper side 15 of the operator interface 4. The handle 17 can be disposed at any position, for example on the underside 16 of the operator interface 4. The handle 17 can, as can be seen from FIG. 14, be disposed so that it can be pivoted if necessary. The operator interface 4 in accordance with FIG. 13 is preferably dimensioned such that the edge of the operator interface 4 identified by the number 18 in FIGS. 13 and 14 rests on the lower arm of the operator 3 in the vicinity of their elbow if the operator 3 is holding the operator interface 4 by the handle 17 and rests on his lower arm.

It is possible for the handle 17 to have a purely mechanical function. Preferably however the handle 17 has at least one actuation element 19, for example a switch or—especially preferably—a button or a sensor button. The actuation element 19 is, if it is present, connected to the evaluation device 9. Actuating the actuation element 19 is evaluated in this case by the evaluation device 9 in addition to the exertion of pressure p on the area 6 of the touchscreen 5. The nature of the possible types of evaluation is diverse. For example it is possible, by means of the actuation element 19 to switch over from special operating mode into normal operating mode (and if necessary also verse versa). Alternatively it is for example possible for an exertion of pressure p on an area 6 of the touchscreen 5 only to be assessed as a valid input when the actuation element 19 is actuated. As an alternative it is possible to switch over between different masks of the touchscreen 5 by—if necessary repeated—actuation of the actuation element 19. It is also possible to use the actuation element 19 in a similar way to a dead man's handle. In this case the button 19 must be pressed and released again in each case after a few seconds, otherwise the operator interface 4 is switched off again or an emergency stop/emergency off of the industrial technical device 1 is initiated. Other methods of operation and combinations of the above-mentioned methods of operation are possible.

The data link between the interfaces 10, 11 of the evaluation device 9 and the control device 2 can be embodied as required. Preferably the interfaces 10, 11 are embodied in accordance with the diagram shown in FIG. 1 as wireless interfaces. In particular they can be embodied as a radio link.

The present invention has many advantages. In particular an intuitive operation of the industrial technical device 1 is possible in a relatively simple manner. Furthermore—by contrast with a slider control implemented by means of the touchscreen 5—it is not possible for there to be a sudden jump to a maximum of a plurality of setpoint values n*. This is because the pressure dependency means that the setpoint values n* have to be run in a predefined sequence.

The inventive, level-triggered detection of the pressure p also provides further evaluation options. In particular it is possible, in accordance with FIG. 15 to detect the applied pressure p as a function of the time t and for example to determine the temporal change dp/dt of the pressure p and evaluate it as well. For example it can be determined whether the temporal derivation dp/dt of the pressure p is at one point or increases over a relatively short minimum period of time beyond a permitted value. If this is the case, this can be evaluated as panic reaction, which triggers an emergency stop or an emergency off of the industrial technical device 1. The corresponding reaction can be initiated regardless of the area 6 of the touchscreen 5 on which the corresponding temporal pressure sequence is applied. Likewise it is possible to initiate an emergency stop or an emergency off of the industrial technical device 1 when the applied pressure p exceeds a maximum permissible level pmax.

It is possible only to initiate an emergency stop or an emergency off if both conditions (too steep an increase and exceeding of the maximum permissible pressure levels pmax) are fulfilled. Preferably an emergency off/emergency stop is however already initiated if only one of the two conditions is fulfilled.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating an industrial technical device, comprising:
(a) applying a pressure on an area of a touchscreen by an operator of the industrial technical device,
(b) generating a value dependent on the applied pressure by a sensor device associated with the area,
(c) supplying the generated value to an evaluation device,
(d) in a normal operating mode, transferring a variable that depends on the applied pressure from the evaluation device to a control device of the industrial technical device,
(e) activating with the control device an element of the industrial technical device and outputting a setpoint value when the pressure defined by the transferred variable exceeds a first threshold value, wherein the setpoint value depends on the applied pressure to the element and is a monotonously increasing function of the pressure, and wherein the setpoint value has a value of zero until the applied pressure increases beyond a second threshold value greater than the first threshold value.

2. The method of claim 1, wherein the first threshold value is greater than a minimum detectable pressure.

3. The method of claim 1, wherein at least one additional discernible pressure level is located between the first threshold value and the second threshold value.

4. The method of claim 1, wherein the setpoint value is selected from a setpoint value representative of a force, a rotational speed and a velocity.

5. The method of claim 1, wherein a derivative of the setpoint value with respect to the pressure is a monotonously increasing function.

6. The method of claim 4, wherein the setpoint value is additionally a function of a state of the industrial technical device at a time when the element is activated.

7. The method of claim 1, further comprising outputting to the operator by means of an actuator a tactile response specific for the setpoint value.

8. The method of claim 1, wherein a plurality of elements is activated depending on the applied pressure, with a number of the activated elements being a monotonously increasing function of the applied pressure.

9. The method of claim 1, wherein steps (b) through (e) are carried out in a failsafe manner.

10. The method of claim 1, further comprising:
starting a timer having a predefined end time when pressure is no longer applied,
resetting the timer when the operator starts again to apply pressure on the area of the touchscreen or on another area of the touchscreen before the predefined end time is reached,
transitioning to a special operating mode when the operator fails to apply pressure on the area of the touchscreen or on another area of the touchscreen before the predefined end time is reached, and
when the operator starts again to apply pressure on the area of the touchscreen or on another area of the touchscreen in the special operating mode, omitting performing steps (d) and (e).

11. The method of claim 10, further comprising
checking in the special operating mode whether the operator is defining a switchover command, wherein the switchover command is represented by an action by the operator different from onetime application of pressure on a single area of the touchscreen, and
transitioning from the special operating mode into the normal operating mode when the switchover command is defined.

12. An industrial technical device, comprising:
an operator interface having a touchscreen with at least one area to which a pressure is applied by an operator of the industrial technical device,
a sensor device associated with the at least one area, the sensor device configured to generate a sensor value dependent on the applied pressure,
a control device having a first interface, and
an evaluation device connected to the sensor device for receiving the sensor value and generating an evaluated variable, wherein the evaluation device comprises a second interface to the control device configured to transfer the evaluated variable to the first interface of the control device,
wherein the control device is configured to activate an element of the industrial technical device and to output to the element a setpoint value dependent on the applied pressure when the applied pressure defined by the evaluated variable exceeds a first threshold value,
wherein the setpoint value is a monotonously increasing function of the applied pressure, and
wherein the setpoint value has a value of zero until the applied pressure becomes greater than a second threshold value greater than the first threshold value.

13. The device of claim 12, wherein the operator interface is constructed as a mobile operator interface.

14. The device as claimed in claim 13, wherein the operator interface comprises a handle.

15. The device of claim 14, wherein the touchscreen is disposed on an upper side of the operator interface and the handle is disposed on a lower side of the operator interface.

16. The device as claimed in claim 14, wherein the handle comprises at least one actuation element having a signaling connection to the evaluation device and wherein the evaluation device detects actuation of the actuation element in addition to application of pressure to the area of the touchscreen.

17. The device of claim 12, wherein at least one of the first interface and second interface is constructed as a wireless interface.
